(19) United States
(12) Patent Application Publication
(10) Pub. No.: US 2026/0266630 A1
(43) Pub. Date: Sep. 10, 2026

(54) ABSOLUTE ENCODER

(71) Applicant: Ming-Chou YEN, Nantou City (TW)

(72) Inventor: Ming-Chou YEN, Nantou City (TW)

(21) Appl. No.: 19/206,109

(22) Filed: May 13, 2025

(30) Foreign Application Priority Data
Mar. 4, 2025 (TW) 114107980

(51) Int. Cl. G01D 5/347; G01D 5/14

(52) U.S. Cl. CPC G01D 5/34707; G01D 5/14; G01D 5/3473; G01D 5/34746

(57) ABSTRACT

A absolute encoder included: a code disc, having a first incremental code track and a second incremental code track; a first sensor signally connected to the first incremental code track and outputting a plurality of first sinusoidal wave analog signals; a second sensor signally connected to the second incremental code track and outputting a plurality of second sinusoidal wave analog signals, the greatest common divisor of the amounts of the first sinusoidal wave analog signals and that of the second sinusoidal wave analog signals is one; and a position converter including a first position converter, a second position converter and a combining circuit module, the first position converter outputs a first digital angle data, the second position converter outputs a second digital angle data, and the combining circuit module combines the first digital angle data and the second digital angle data to an absolute position.

### BACKGROUND OF THE INVENTION

### Technical Field

The present invention relates to an absolute encoder, especially to a dual-code-track absolute encoder, in which a code disc thereof is disposed with a first incremental code track and a second incremental code track, thus a design of utilizing less amounts of the code tracks to reduce the volume of the encoder is provided, so that the absolute encoder achieves effects of being smaller and miniaturized.

### Description of Related Art

A conventional server motor available in the market is often disposed with an encoder therein, which can be named as a rotary encode or a linear encoder. The encoder provides an angle of a rotor to obtain a motor position data. The motor position data can be fed back to a relevant server control unit to precisely control the position of the motor, the rotating speed and the acceleration. In the server motor, a position sensor on a rotation shaft is defined as an encoder, and the position precision of the server motor is determined according to the resolution level of the encoder.

Please refer to FIG. 1, which is a schematic planar view showing the convention rotary code disc of the absolute encoder; wherein the rotary code disc 500 is a provided with a code disc design with 6 bits gray code. The rotary code disc 500 includes a rotary main body 510 and a plurality of optical gratings. The optical gratings includes a first optical grating 511 located at a first code track arranged at the most inner side and occupying ½ of the circumference, two second optical gratings 512 and occupying ¼ of the circumference, plural third optical grating 513, plural fourth optical grating 514 and plural fifth optical grating 515 located at a second code track from outer side arranged at an inner side of last code track 516, and 32 sixth optical grating 516 located at the most outer side of the code track and respectively occupying 1/64 of the circumference. As such, different bright/dark signals can be generated along the radial direction, and the resolution with 64 resolution along the circumferential direction is achieved.

However, in the absolute encoder shown in FIG. 1, the resolution increases 1 bit, the code disc has to increase one more track of the code tracks, the higher the resolution, the more the amounts of the code tracks, thus the volume of the encoder becomes larger. Accordingly, the precision of the absolute encoder is limited when the absolute encoder is desired to be applied in a field with a volume limitation.

Based on what has been disclosed above, the applicant of the present invention has devoted himself for testing and researching with a tireless spirit. A novel absolute encoder has been invented. A code disc of the absolute encoder is disposed with a first incremental code track and a second incremental code track to provide a dual-code-track absolute encoder, which utilizes less amount of the code tracks to reduce the volume of the encoder, thus the absolute encoder achieves effects of being smaller and miniaturized.

### SUMMARY OF THE PRESENT INVENTION

One primary objective of the present invention is to provide an absolute encoder, in which a code disc thereof is disposed with a first incremental code track and a second incremental code track, a design of utilizing less amounts of the code tracks to precisely locate the position and reduce the volume of the encoder is provided, so that the absolute encoder achieves effects of being smaller and miniaturized.

For achieving said objective, one technical solution provided by the present invention is to provide an absolute encoder, which included: a code disc, having a first incremental code track and a second incremental code track, wherein the second incremental code track is disposed at an inner side of the first incremental code track; a first sensor signally connected to the first incremental code track, wherein the first incremental code track has a plurality of first code blocks, the first sensor is used to sense the first code blocks and output a plurality of first sinusoidal wave analog signals; a second sensor signally connected to the second incremental code track, wherein the second incremental code track has a plurality of second code blocks, the second sensor is used to sense the second code blocks and output a plurality of second sinusoidal wave analog signals, the greatest common divisor of the amounts of the first sinusoidal wave analog signals and that of the second sinusoidal wave analog signals is one; and a position converter including a first position converter, a second position converter and a combining circuit module, wherein the first position converter is signally connected to the first sensor, the first position converter is used to convert the first sinusoidal wave analog signals and output a first digital angle data, the second position converter is signally connected to the second sensor, the second position converter is used to convert the second sinusoidal wave analog signals and output a second digital angle data, the combining circuit module is signally connected to the first position converter and the second position converter, the combining circuit module is used to combine the first digital angle data and the second digital angle data to an absolute position, wherein the position converter is used to convert the signals inputted by the first sensor and the second sensor into a position data.

According to the aforesaid absolute encoder, wherein the absolute encoder is a disc encoder.

According to the aforesaid absolute encoder, wherein the absolute encoder is a linear encoder.

According to the aforesaid absolute encoder, wherein the absolute encoder is an optical encoder.

According to the aforesaid absolute encoder, wherein the absolute encoder is a magnetic encoder.

According to the aforesaid absolute encoder, wherein the combining circuit module is selected from a group including any one of a hardware, a firmware and a software.

Another objective of the present invention is to provide an absolute encoder, which has advantages of precisely and rapidly positioning and reducing the position identifying errors.

For achieving said objective, one technical solution provided by the present invention is to provide an absolute encoder, which included: a code disc having a first incremental code track, a second incremental code track and a third incremental code track, wherein the second incremental code track is disposed at an inner side of the first incremental code track, and the third incremental code track is disposed at an inner side of the second incremental code track; a first sensor signally connected to the first incremental code track, wherein the first incremental code track has a plurality of first code blocks, the first sensor is used to sense the first code blocks and output a plurality of first sinusoidal wave analog signals; a second sensor signally connected to the second incremental code track, wherein the second incremental code track has a plurality of second code blocks, the second sensor is used to sense the second code blocks and output a plurality of second sinusoidal wave analog signals; a third sensor signally connected to the third incremental code track, wherein the third incremental code track has a third code block, the third incremental code track is disposed at an inner side of the second incremental code track, the third sensor is used to sense the third code block and output a third signal, and the greatest common divisor of the amounts of the first sinusoidal wave analog signals, that of the second sinusoidal wave analog signals and the third signal is one; and a position converter including a first position converter, a second position converter and a combining circuit module, the first position converter is signally connected to the first sensor, the first position converter is used to convert the first sinusoidal wave analog signals and output a first digital angle data, the second position converter is signally connected to the second sensor, the second position converter is used to convert the second sinusoidal wave analog signals and output a second digital angle data, the combining circuit module is signally connected to the first position converter and the second position converter, the combining circuit module is used to combine the first digital angle data, the second digital angle data and the third signal to an absolute position data, wherein the position converter is used to convert the signals inputted by the first sensor, the second sensor and the third sensor into a position data.

According to the aforesaid absolute encoder, wherein the absolute encoder is a disc encoder.

According to the aforesaid absolute encoder, wherein the absolute encoder is a linear encoder.

According to the aforesaid absolute encoder, wherein the absolute encoder is an optical encoder.

According to the aforesaid absolute encoder, wherein the absolute encoder is a magnetic encoder.

According to the aforesaid absolute encoder, wherein the combining circuit module is selected from a group including any one of a hardware, a firmware and a software.

The summary of the present invention is used to illustrate a certain selected concepts with a simplified manner, the detailed description provided as follows would provide further descriptions. The summary of the present invention is not intended to identify the technological features and the fundamental features nor limit the scope of the present invention.

### BRIEF DESCRIPTION OF THE DRAWINGS

With detailed descriptions and the drawings, the drawings of the embodiments of the present invention may be comprehensively understood; as such, the drawing are merely used to explain the embodiments of the present invention, and shall not be served as limitations to the scope of the present invention.

FIG. 1 is a schematic planar view showing the convention code disc;

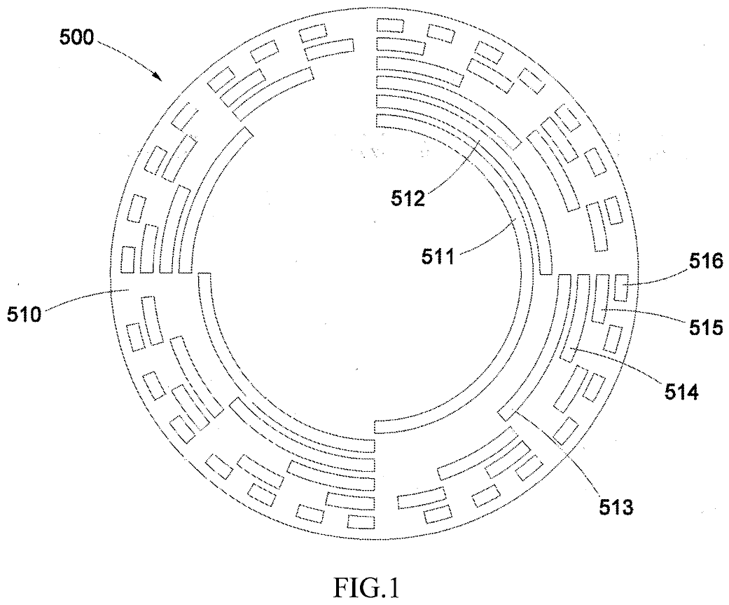

FIG. 2 is a schematic planar view showing the code disc according to the first embodiment of the present invention;

FIG. 3 is a block diagram according to the first embodiment of the present invention;

FIG. 4 is a schematic view showing the sinusoidal wave analog signal being outputted according to the first embodiment of the present invention;

FIG. 5 is a schematic view showing the digital angle data being outputted according to the first embodiment of the present invention;

FIG. 6 is a schematic view showing the absolute position data being outputted according to the first embodiment of the present invention;

FIG. 7 is a schematic planar view showing the code disc according to the second embodiment of the present invention; and

FIG. 8 is a block diagram according to the second embodiment of the present invention;

### BRIEF DESCRIPTION OF THE DRAWINGS

10: Code disc
11: First incremental code track
12: Second incremental code track
13: Third incremental code track
111: Frist code block
121: Second code block
131: Third code block
21: First sensor
22: Second sensor
23: Third sensor
211: First sinusoidal wave analog signal
221: Second sinusoidal wave analog signal
231: Third signal
31: First position converter
32: Second position converter
33: Position converter
311: First digital angle data
321: Second digital angle data
40: Combining circuit module
401: Absolute position data
500: Rotary code disc
510: Rotary main body
511: Frist optical grating
512: Second optical grating
513: Third optical grating
514: Fourth optical grating
515: Fifth optical grating
516: Sixth optical grating

### DETAILED DESCRIPTION

The detailed illustrations and technical contents and the drawings are provided as follows. However the drawings are merely used to provide references and illustrations, and should not be served as limitations to the present invention. The embodiments combined with the drawings are severed to provide detailed illustrations for the present invention, but the present invention is not limited to the disclosed embodiments. The present invention is deemed to cover replacements, amendments, solutions and findings having the same effects according to the spirits and the scope of the present invention. For providing the clear understandings to the public, the preferred embodiment of the present invention fully illustrates the substantial details, thus the skilled people in the art may fully understand the present invention without these detailed descriptions.

The technical contents of this invention will become apparent with the detailed description of embodiments accompanied with the illustration of related drawings as follows. It is intended that the embodiments and drawings disclosed herein are to be considered illustrative rather than restrictive.

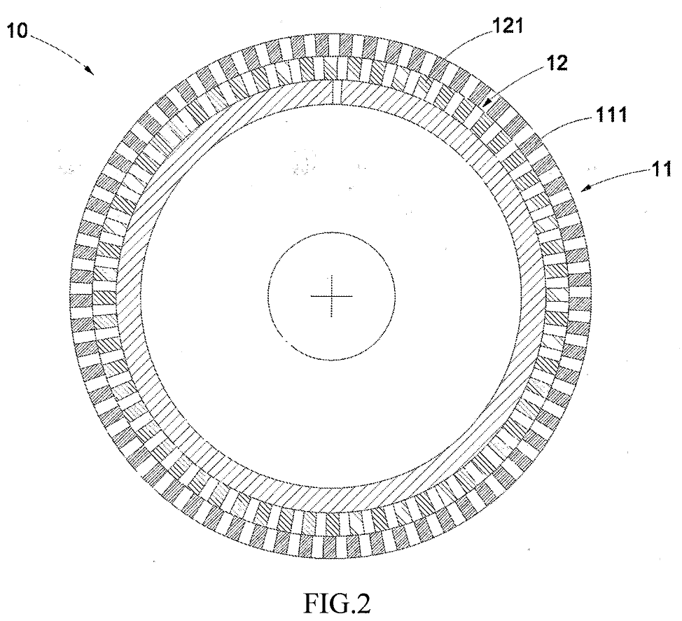

Please refer to FIG. 2, which is a schematic planar view showing the code disc according to the first embodiment of the present invention. According to the first embodiment, a code disc 10 of an absolute encoder of the present invention is provided to a dual-code-track absolute encoder. The code disc 10 is disposed with a first incremental code track 11 and a second incremental code track 12, and the second incremental code track 12 is arranged at an inner side of the first incremental code track 11. Wherein, the first incremental code track 11 has a plurality of first code blocks 111, and the second incremental code track 12 has a plurality of second code blocks 121. According to the present invention, the absolute encoder provides a design of utilizing less amounts of the code tracks to precisely locate the position and reduce the volume of the encoder, so that the absolute encoder achieves effects of being smaller and miniaturized.

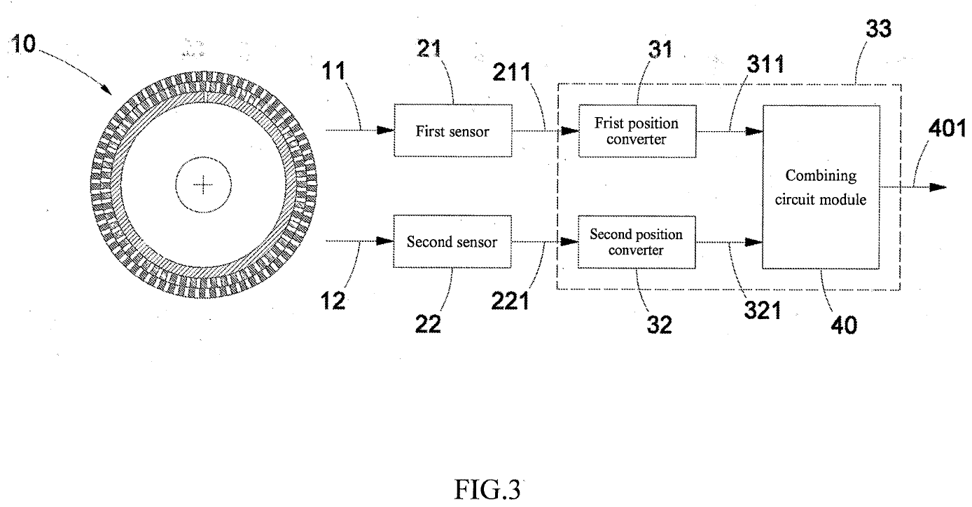

Please refer to FIG. 3, which is a block diagram according to the first embodiment of the present invention. When the absolute encoder of the present invention is in actual practices, the absolute encoder include: a code disc 10, having a first incremental code track 11 and a second incremental code track 12, and the second incremental code track 12 is disposed at an inner side of the first incremental code track 11; a first sensor 21 signally connected to the first incremental code track 11, the first incremental code track 11 has a plurality of first code blocks 111, the first sensor 21 is used to sense the first code blocks 111 and output a plurality of first sinusoidal wave analog signals 211; a second sensor 22 signally connected to the second incremental code track 12, the second incremental code track 12 has a plurality of second code blocks 121, the second sensor 22 is used to sense the second code blocks 121 and output a plurality of second sinusoidal wave analog signals 221, the greatest common divisor of the amounts of the first sinusoidal wave analog signals 211 and that of the second sinusoidal wave analog signals 221 is one; and a position converter 33 including a first position converter 31, a second position converter 32 and a combining circuit module 40, the first position converter 31 is used to convert the first sinusoidal wave analog signals 211 and output a first digital angle data 311, the second position converter 32 is signally connected to the second sensor 22, the second position converter 32 is used to convert the second sinusoidal wave analog signals 221 and output a second digital angle data 321, the combining circuit module 40 is signally connected to the first position converter 31 and the second position converter 32, the combining circuit module 40 is used to combine the first digital angle data 311 and the second digital angle data 321 to an absolute position data 401, wherein the combining circuit module 40 is selected from a group including any one of a hardware, a firmware and a software, wherein the position converter 33 is used to convert the signals inputted by the first sensor 21 and the second sensor 22 into a absolute position data.

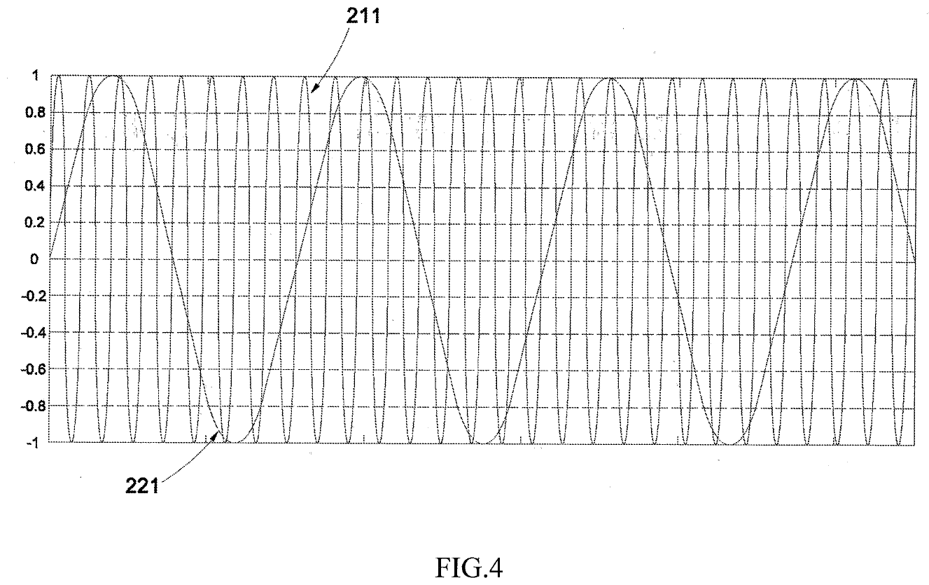

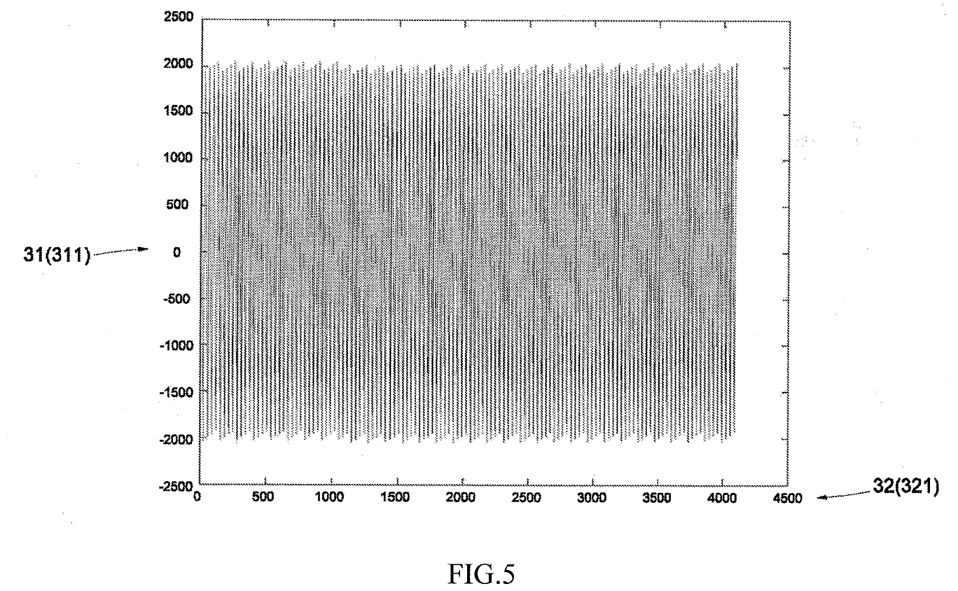

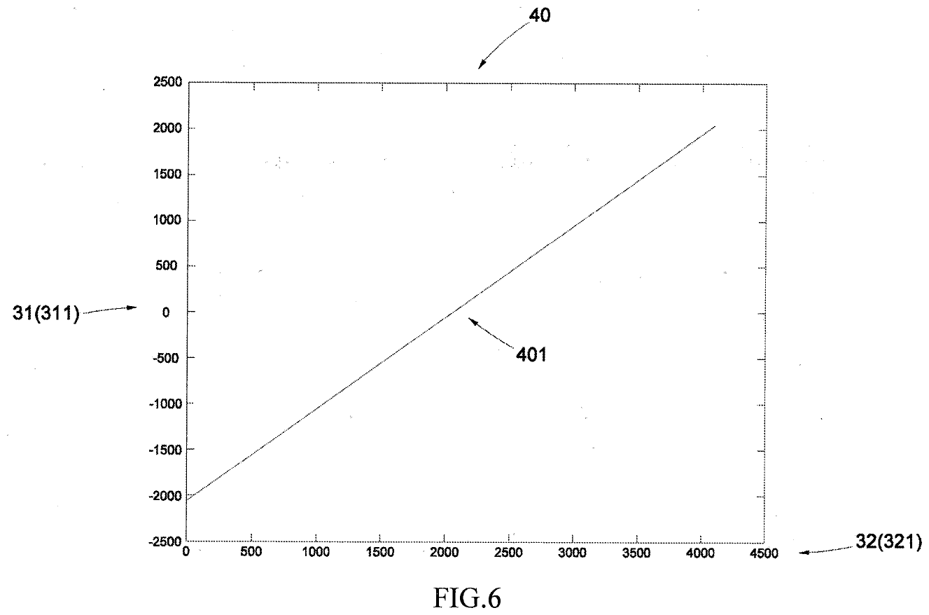

Please refer from FIG. 4 to FIG. 6, wherein FIG. 4 is a schematic view showing the sinusoidal wave analog signal being outputted according to the first embodiment of the present invention. The first sensor 21 of the absolute encoder provided by the present invention is used to sense the first blocks 111 and output the plurality of the first sinusoidal wave analog signals 211, a cycle per revolution (CPR) of the first sinusoidal wave analog signals 211 is 1024 (CPR), the second sensor 22 is used to sense the second code blocks 121 and output the plurality of the second sinusoidal wave analog signals 221, a cycle per revolution (CPR) of the second sinusoidal wave analog signals 221 is 127 (CPR), and the greatest common divisor of the 1024 (CPR) and the 127 (CPR) is one. Please refer to FIG. 5, which is a schematic view showing the digital angle data being outputted according to the first embodiment of the present invention. As shown in FIG. 5, the first position converter 31 is used to convert the first sinusoidal wave analog signals 211 and output the first digital angle data 311, the second position converter 32 is used to convert the second sinusoidal wave analog signals 221 and output the second digital angle data 321. Please refer to FIG. 6, which is a schematic view showing the absolute position data being outputted according to the first embodiment of the present invention. As shown in FIG. 6, the combining circuit module 40 is used to combine the first digital angle data 311 and the second digital angle data 321 to the absolute position data 401. Accordingly, with the absolute encoder provided by the present invention, after the first digital angle data 311 and the second digital angle data 321 are combined, the absolute encoder of the present invention is able to easily identify the position where the encoder stops. As such, the absolute encoder of the present invention provides a design of utilizing less amounts of the code tracks to precisely locate the position and reduce the volume of the encoder, so that the absolute encoder achieves effects of being smaller and miniaturized.

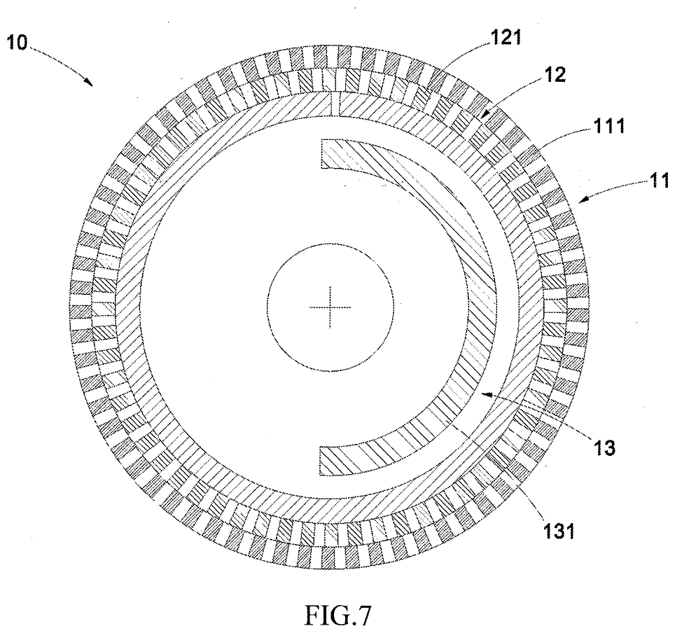

Please refer to FIG. 7, which is a schematic planar view showing the code disc according to the second embodiment of the present invention. According to the second embodiment, a code disc of the absolute encoder of the present invention is disposed with a first incremental code track 11, a second incremental code track 12 and a third incremental code track 13. The second incremental code track 12 is disposed at an inner side of the first incremental code track 11, the third incremental code track 13 is disposed at an inner side of the second incremental code track 12. Wherein, the first incremental code track 11 has a plurality of first code blocks 111, the second incremental code track 12 has a plurality of second code blocks 121, and the third incremental code track 13 has a third code blocks 131. Accordingly, the absolute encoder of the present invention provides a design of utilizing less amounts of the code tracks to precisely locate the position and reduce to volume of the encoder, so that the absolute encoder achieves effects of being smaller and miniaturized, and the absolute encoder has advantages of precisely and rapidly positioning and reducing the position identifying errors.

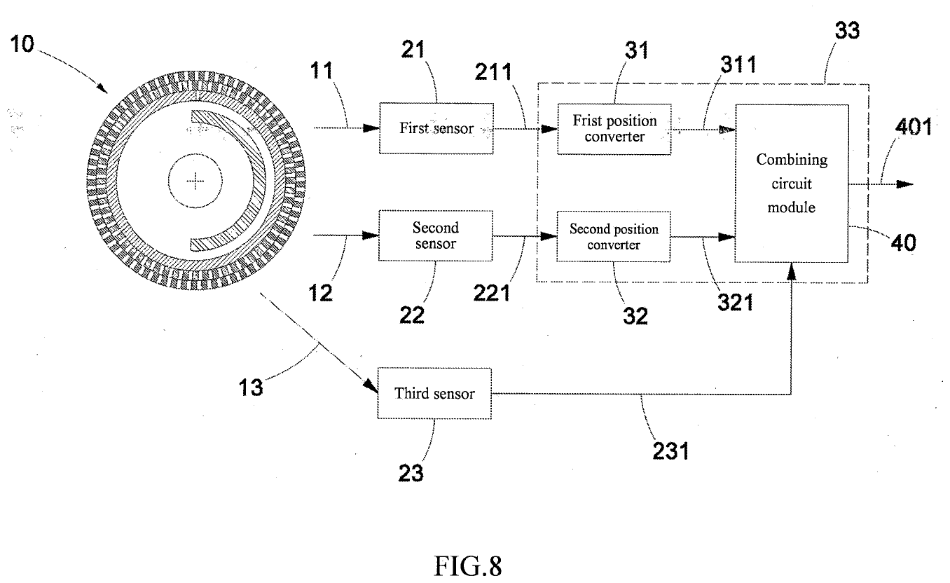

Please refer to FIG. 8, which is a block diagram according to the second embodiment of the present invention. When the absolute encoder of the present invention is in actual practices, the absolute encoder includes: a code disc 10 having a first incremental code track 11, a second incremental code track 12 and a third incremental code track 13. The second incremental code track 12 is disposed at an inner side of the first incremental code track 11, and the third incremental code track 13 is disposed at an inner side of the second incremental code track 12; a first sensor 21 signally connected to the first incremental code track 11, the first incremental code track 11 has a plurality of first code blocks 111, the first sensor 21 is used to sense the first code blocks 111 and output a plurality of first sinusoidal wave analog signals 211; a second sensor 22 signally connected to the second incremental code track 12, the second incremental code track 12 has a plurality of second code blocks 121, the second sensor 22 is used to sense the second code blocks 121 and output a plurality of second sinusoidal wave analog signals 221; a third sensor 23 signally connected to the third incremental code track 13, the third incremental code track 13 has a third code block 131, the third incremental code track 13 is disposed at an inner side of the second incremental code track 12, the third sensor 23 is used to sense the third code block 131 and output a third signal 231. The greatest common divisor of the amounts of the first sinusoidal wave analog signals 211, that of the second sinusoidal wave analog signals 221 and the third signal 231 is one; and a position converter 33 including a first position converter 31, a second position converter 32 and a combining circuit module 40, the first position converter 31 is signally connected to the first sensor 21. The first position converter 31 is used to convert the first sinusoidal wave analog signals 211 and output a first digital angle data 311, the second position converter 32 is signally connected to the second sensor 22. The second position converter 32 is used to convert the second sinusoidal wave analog signals 221 and output a second digital angle data 321, the combining circuit module 40 is signally connected to the first position converter 31, the second position converter 32 and the third signal 231, the combining circuit module 40 is used to combine the first digital angle data 311, the second digital angle data 321 and the third signal 231 to an absolute position data 401, wherein the combining circuit module 40 is selected from a group including any one of a hardware, a firmware and a software, wherein the position converter 33 is used to convert the signals inputted by the first sensor 21, the second sensor 22 and the third sensor 23 into a position data.

When the absolute encoder of the present invention rotates to perform the actual practices, in order to prevent the sinusoidal wave from being reduplicated when the rotating motion has already passed half of the rotating process, and the rotating position cannot be identified as stopping at the front half portion or the rear half portion currently, thus the third incremental code track 13 is required to identify the current position being at the front half portion or the rear half portion, the black color (representing 0) is identified as being at the front half portion when the rotating motion stops at the third code block 131 of the third incremental code track 13, the white color (representing 1) is identified as being at the rear half portion when the rotating motion stops at the third incremental code track 13. As such, the absolute encoder of the present invention has advantages of precisely and rapidly positioning and reducing the position identifying errors.

When the absolute encoder of the present invention is in the actual practices, the absolute encoder can be a disc encoder, a linear encoder, an optical encoder or a magnetic encoder.

While this invention has been described by means of specific embodiments, numerous modifications and variations may be made thereto by those skilled in the art without departing from the scope and spirit of this invention set forth in the claims. Some amendments or modifications may be applied; thus the scope of the present invention shall be defined as within the claims provided by the present invention. However, the aforesaid embodiments are merely used to illustrate the features and the effects of the present invention, and shall not be used to limit the applicable range of the present invention; should the spirits and the technologies disclosed by the present invention are not deviated, the changes and the medications having the same effects achieve according to the disclosure provided in the present invention are still within the scope of the present invention.

What is claimed is:

1. An absolute encoder, including:
a code disc, having a first incremental code track and a second incremental code track, wherein the second incremental code track is disposed at an inner side of the first incremental code track;
a first sensor, signally connected to the first incremental code track, wherein the first incremental code track has a plurality of first code blocks, the first sensor is used to sense the first code blocks and output a plurality of first sinusoidal wave analog signals;
a second sensor, signally connected to the second incremental code track, wherein the second incremental code track has a plurality of second code blocks, the second sensor is used to sense the second code blocks and output a plurality of second sinusoidal wave analog signals, and a greatest common divisor of an amounts of the first sinusoidal wave analog signals and that of the second sinusoidal wave analog signals is one; and
a position converter, including a first position converter, a second position converter and a combining circuit module, wherein the first position converter is signally connected to the first sensor, the first position converter is used to convert the first sinusoidal wave analog signals and output a first digital angle data, the second position converter is signally connected to the second sensor, the second position converter is used to convert the second sinusoidal wave analog signals and output a second digital angle data, the combining circuit module is signally connected to the first position converter and the second position converter, the combining circuit module is used to combine the first digital angle data and the second digital angle data to an absolute position.

2. The absolute encoder according to claim 1, wherein the absolute encoder further includes a third incremental code track, the third incremental code track is disposed at an inner side of the second incremental code track, the third incremental code track has a third code block, the third incremental code track is signally connected to a third sensor, the third sensor is signally connected to the combining circuit module, the third sensor is used to sense the third code block and output a third signal, and a greatest common divisor of an amounts of the first sinusoidal wave analog signals, that of the second sinusoidal wave analog signals and the third signal is one.

3. The absolute encoder according to claim 2, wherein the combining circuit module is selected from a group including any one of a hardware, a firmware and a software.

4. The absolute encoder according to claim 2, wherein the third sensor utilizes the position converter to converter signals inputted by the third sensor into a position data.

5. The absolute encoder according to claim 1, wherein the absolute encoder is a disc encoder.

6. The absolute encoder according to claim 1, wherein the absolute encoder is a linear encoder.

7. The absolute encoder according to claim 1, wherein the absolute encoder is an optical encoder.

8. The absolute encoder according to claim 1, wherein absolute encoder is a magnetic encoder.

9. The absolute encoder according to claim 1, wherein the combining circuit module is selected from a group including any one of a hardware, a firmware and a software.

10. The absolute encoder according to claim 1, wherein the position converter is used to convert signals inputted by the first sensor and the second sensor into a absolute position data.
